(19) United States
(12) Patent Application Publication
(10) Pub. No.: US 2004/0120976 A1
(43) Pub. Date: Jun. 24, 2004

(54) Microencapsulated insecticidal composition

(75) Inventors: Keiichiro Inui, Matsubara-shi (JP); Takahiro Shigemura, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/702,643

(22) Filed: Nov. 7, 2003

(30) Foreign Application Priority Data
Nov. 8, 2002 (JP) 2002-324963

(51) Int. Cl. A01N 65/00; A01N 25/00; A01N 25/34

(52) U.S. Cl. 424/405; 424/408; 514/65

(57) ABSTRACT

A microencapsulated insecticidal composition comprising a pyrethrin encapsulated in a wall formed of a synthetic polymer and having an average particle diameter of 5 to 100 μm and wall thickness of 0.03 to 1 μm is effective for controlling insects.

### FIELD OF THE INVENTION

The present invention relates to a microencapsulated insecticidal composition.

### BACKGROUND ART

It is known that a microencapsulated synthetic pyrethroid compound having a 3-phenoxy group is used for controlling cockroaches in U.S. Pat. No. 5,063,059. Further, it is also known that a microencapsulated various pyrethroid compound is used for controlling insects in agricultural field in GB-2, 187,957.

On the other hand, it is known that a microencapsulated organophosphorus insecticide is used for controlling termites in U.S. Pat. No. 4,900,551.

### SUMMARY OF THE INVENTION

The present invention provides a microencapsulated insecticidal composition comprising a pyrethrin encapsulated in a wall formed of a synthetic polymer and having an average particle diameter of 5 to 100 μm, preferably 10 to 50 μm, and wall thickness of 0.03 to 1 μm and its use.

### DISCLOSURE OF THE INVENTION

In the present invention, pyrethrin means pyrethrin I, pyrethrin II, cinerin I, cinerin II, jasmolin I, jasmolin II or mixtures thereof. Natural pyrethrins, which contain the above-mentioned six insecticidal compounds, are usually available, but the pyrethrin obtained by organic synthesis may be used.

Pyrethrin is microencapsulated in the present invention. The microcapsule may contain pyrethrin solely as well as a solution of pyrethrin. Examples of the solvent used for the solution include dimethylnaphthalene, dodecylbenzene, liquid paraffin, isophorone, kerosene, dibutyl adipate, diethyl phthalate, diethylene glycol monobutyl ether acetate, propylene carbonate, coconut oil, rapeseed oil, cottonseed oil, castor oil, soybean oil and corn oil, but any inert organic solvents can be used if only to have compatibility with pyrethrin. The solvent may be a mixture of two or more kinds of the organic solvents mentioned above. Further, liquid or solid substances may be added for adjusting specific gravity of pyrethrin or pyrethrin solution. Synergist such as piperonyl butoxide may be added to the pyrethrin. Furthermore, auxiliaries such as stabilizer, antioxidant, and so on may be added.

The microcapsules of the present invention can be prepared by any known methods, but interfacial polymerization method is preferably utilized because it is convenient to control the particle size and wall thickness. Microencapsulation by the interfacial polymerization method is well known, for example, in U.S. Pat. No. 4,900,551, GB-2,187,957 and U.S. Pat. No. 5,063,059.

The microcapsule wall is formed of a synthetic polymer in the present invention. Examples of the synthetic polymer include polyurethane, polyurea, polyamide, polyester and polycarbonate. Polyurethane and polyurea are preferably used.

Polyurethane microcapsule can be prepared, for example, as follows: A solution containing a pyrethrin and a polyfunctional isocyanate compound having at least two isocyanate groups is dispersed in an aqueous solution containing a dispersing agent and polyvalent alcohol at least two hydroxy groups, followed by an interfacial polymerization. Or a solution containing a pyrethrin and a polyfunctional isocyanate compound having at least two isocyanate groups is dispersed in an aqueous solution containing a dispersing agent, to which polyvalent alcohol at least two hydroxy groups is added, followed by an interfacial polymerization.

Polyurea microcapsule can be prepared, for example, as follows: A solution containing a pyrethrin and a polyfunctional isocyanate compound having at least two isocyanate groups is dispersed in an aqueous solution containing a dispersing agent with or without polyfunctional amine having at least two amino groups, followed by an interfacial polymerization. Or a solution containing a pyrethrin and a polyfuctional isocyanate compound having at least two isocyanate groups is dispersed in an aqueous solution containing a dispersing agent, followed by an interfacial polymerization after addition of polyfunctional amine having at least two amino groups to the dispersed solution.

Examples of the polyfunctional isocyanate compound used for polyurethane and polyurea include toluene diisocyanate, hexamethylene diisocyanate, adducts of toluene diisocyanate and trimethylolpropane, self-condensates of hexamethylene diisocyanate, Sumidur L (Sumika-Bayer Urethane Company) and Sumidur N (Sumika-Bayer Urethane Company). Examples of the polyvalent alcohol used for polyurethane include ethylene glycol, propylene glycol, butylenes glycol, hexanediol, heptanediol, dipropylene glycol, triethylene glycol, glycerin, resorcinol and hydroquinone, Examples of the polyfunctional amine used for polyurea include ethylenediamine, hexamethylenediamine, phenylenediamine, toluenediamine and diethylenetriamine.

Examples of the dispersing agent include natural polysaccharides such as gum arabic; semi-synthetic polysaccharides such as methylcellulose and carboxymethylcellulose; synthetic polymers such as polyvinyl alcohol; and fine mineral powders such as magnesian aluminum silicate.

The other synthetic polymer microcapsules can be prepared by known methods similar to the above description.

The average particle diameter and wall thickness of the microcapsule can be controlled by the amount of the wall material and the degree of mechanical agitation, and further varieties and concentration of the dispersing agent.

The microencapsulated insecticidal composition of the present invention can be any type of insecticidal formulation, but usually aqueous suspension.

The aqueous suspension contains the pyrethrin encapsulated in a wall formed of a synthetic polymer and having an average particle diameter of 5 to 100 μm, preferably 10 to 50 μm, and wall thickness of 0.03 to 1 μm. A pyrethrin-microencapsulated insecticidal composition having too small average particle diameter tends to have less effectiveness for controlling insects, on the other hand, a pyrethrin-microencapsulated insecticidal composition having too large average particle diameter has less stability. The aqueous suspension comprises the microencapsulated pyrethrin, dispersant, water and optionally chelating agent, antirusting agent, antifoaming agent, antimicrobials, pH adjusting agent, gravity adjusting agent and so on. The pH of the aqueous suspension is preferably 2 or more and less than 7, more preferably in the range of 2 to 6.5.

The amount of the pyrethrin in the insecticidal composition of the present invention is usually 1 to 40%, preferably 3 to 15% by weight.

The average particle diameter is a median (diameter at 50% cumulative volume) and can be measured with particle distribution by laser diffraction, for example SALD-200 (manufactured by Shimadzu Corporation). The wall thickness can be calculated approximately by the following equation:

Wall thickness=(Vm/Vc)×(d/6)

wherein Vm is a volume of a wall material, Vc is a volume of a core substance and d is an average particle diameter of microcapsules.

The insecticidal composition of the present invention is used for controlling insects, typically wood harmful insects such as termites, insanitary insects such as cockroaches, unpleasant insects such as ants and agriculturally harmful insects.

Examples of the target pests include Isopteran insects such as Coptotermes formosanus (Formosan subterranean termite), Reticulitermes speratus and Incisitermes minor; Dictyopteran insects such as Blattella germanica (German cockroach), Periplaneta fuliginosa (smoky brown cockroach) and Periplaneta americana (American cockroach); Coleopteran insects such as Lyctus brunneus (powder post beetle), Lasioderma serricorne (cigarette beetle), Dermestidae (hide beetles) and Scarabaeidae (scarabs); Lepidopteran insects such as Mamestra brassicae (cabbage armyworm), Pieris rapae crucivora (common cabbageworm), Spodoptera litura (tobacco cutworm) and Helicoverpa armigera (tobacco budworm); Hymenopteran insects such as Camponotus japonicus, Pristomyrmex pungens and Athalia rosae ruficornis (cabbage sawfly), Orthopteran insects such as Oxya yezoensis (rice grasshopper) and Gryllidae (crickets); Hemipteran insects; Dipteran insects; and other insects.

When the insecticidal composition of the present invention is used for controlling insects, the application amount is usually 0.1 to 100 g/m² in the amount of pyrethrin.

When the insecticidal composition of the present invention is used for controlling termites, the insecticidal composition is applied to a soil or concrete surface under a house in the dosage of 0.1 to 100 g/m², preferably 1 to 10 g/m², in the amount of pyrethrin, after diluting with water if necessary. The insecticidal composition is also applied to wood in the dosage of 0.1 to 10 g/m² in the amount of pyrethrin, after diluting with water if necessary.

When the insecticidal composition of the present invention is used for controlling cockroaches, the insecticidal composition is applied to a floor or the like where cockroaches inhabit, after diluting with water if necessary. It is preferable to apply 0.1 to 10 g/m² in the amount of pyrethrin and 10 to 1000 ml/m² of application diluent.

When the insecticidal composition of the present invention is used for controlling agricultural insects, the insecticidal composition is applied to the crops or the like where the insects inhabit, after diluting with water if necessary. It is preferable to apply 100 to 10000 liters/hectare in the amount of the application diluent

### EXAMPLES

The present invention is explained in more detail by the following examples. In the examples, percent (%) means percent (%) by weight.

### Example 1

Ninety-six grams (96 g) of PYROCIDE-50 (50% natural pyrethrins, McLaughlin Gormley King Company) and 4 g of Sumidur L (polyisocyanate, Sumika-Bayer Urethane Company) were mixed to give an oily liquid. On the other hand, 6 g of gum arabic and 2.9 g of ethylene glycol were dissolved in 120 g of ion-exchange water to give an aqueous solution. While the aqueous solution was stirred at 4500 rpm by T. K. Homomixer. (Tokushukika Kogyo Comapny), the oily liquid was added thereto and continued to stir for 30 minutes to give a dispersion. The dispersion was allowed to proceed with stirring at 500 rpm in a constant temperature bath of 60° C. for 14 hours to give a suspension of microencapsulated composition To the suspension was added aqueous solution containing 0.2% of Kelzan S (xanthan gum, Sansho Company) to make the concentration of natural pyrethrins 10%. The average particle diameter was measured and the result of 19 μm was obtained. The wall thickness was 0.12 μm and pH was 6.0.

### Example 2

Ninety-six grams (96 g) of PYROCIDE-50 (50% natural pyrethrins, McLaughlin Gormley King Company) and 4 g of Sumidur L (polyisocyanate, Sumika-Bayer Urethane Company) were mixed to give an oily liquid. On the other hand, 6 g of gum arabic and 2.9 g of ethylene glycol were dissolved in 120 g of ion-exchange water to give an aqueous solution. While the aqueous solution was stirred at 6000 rpm by T. K. Homomixer (Tokushukika Kogyo Comapny), the oily liquid was added thereto and continued to stir for 30 minutes to give a dispersion. The dispersion was allowed to proceed with stirring at 500 rpm in a constant temperature bath of 60° C. for 14 hours to give a suspension of microencapsulated composition. To the suspension was added aqueous solution containing 0.2% of Kelzan S (xanthan gum, Sansho Company) to make the concentration of natural pyrethrins 10%. The average particle diameter was measured and the result of 12 μm was obtained. The wall thickness was 0.08 μm and pH was 5.8.

### Example 3

Ninety-six grams (96 g) of PYROCIDE-50 (50% natural pyrethrins, McLaughlin Gormley King Company) and 4 g of Sumidur L (polyisocyanate, Sumika-Bayer Urethane Company) were mixed to give an oily liquid. On the other hand, 6 g of gum arabic and 2.9 g of ethylene glycol were dissolved in 120 g of ion-exchange water to give an aqueous solution while the aqueous solution was stirred at 6000 rpm by T. K. Homomixer (Tokushukika Kogyo Comapny), the oily liquid was added thereto and continued to stir for 30 minutes to give a dispersion. The dispersion was allowed to proceed with stirring at 500 rpm in a constant temperature bath of 60° C. for 14 hours to give a suspension of microencapsulated composition. To the suspension was added aqueous solution containing 0.2% of Kelzan S (ranthan gum, Sansho Company) and then 1% aqueous solution of lactic acid to make the concentration of natural pyrethrins 10%. The average particle diameter was measured and the result of 12 μm was obtained. The wall thickness was 0.08 μm and pH was 3.0.

### Example 4

Forty-eight grams (48 g) of PYROCIDE-50 (50% natural pyrethrins, McLaughlin Gormley King Company), 48 g of piperonyl butoxide and 5 g of Sumidur L (polyisocyanate, Sumika-Bayer Urethane Company) were mixed to give an oily liquid. On the other hand, 6 g of Gohsenol (polyvinyl alcohol, Nippon Synthetic Chemical Industry) and 3.2 g of ethylene glycol were dissolved in 120 g of ion-exchanged water to give an aqueous solution. While the aqueous solution was stirred at 4000 rpm by T. K. Homomixer (Tokushukika Kogyo Comapny), the oily liquid was added thereto and continued to stir for 30 minutes to give a dispersion. The dispersion was allowed to proceed with stirring at 500 rpm in a constant temperature bath of 60° C. for 14 hours to give a suspension of microencapsulated composition. To the suspension was added aqueous solution containing 0.2% of Kelzan S (xanthan gum, Sansho Company) to make the concentration of natural pyrethris 5%. The average particle diameter was measured and the result of 17 μm was obtained. The wall thickness was 0.10 μm and pH was 5.7.

### Reference Example 1

Twenty grams (20 g) of PYROCIDE-50 (50% natural pyrethrins, McLaughlin Gormley King Company), 15 g of New Karugen CP-120 (surfactant, Takemotoyushi Company) and 75g of IP Solvent (hydrocarbon, Idemitsu Petrochemical Company) were mixed to give an emulsifiable concentrate.

### Reference Example 2

Ten grams (10 g) of fenitrothion (organophosphorus insecticidal compound), 15 g of New Karugen CP-120 (surfactant, Takemotoyushi Company) and 75 g of IP Solvent (hydrocarbon, Idemitsu Petrochemical Company) were mixed to give an emulsifiable concentrate,

### Reference Example 3

Forty-eight grams (48 g) of fenitrothion, 48 g of diisobutyl adipate and 4 g of Sumidur L (polyisocyanate, Sumika-Bayer Urethane Company) were mixed to give an oily liquid. On the other hand, 6 g of Gohsenol (polyvinyl alcohol, Nippon Synthetic Chemical Industry) and 2.9 g of ethylene glycol were dissolved in 120 g of ion-exchanged water to give an aqueous solution. While the aqueous solution was stirred at 4500 rpm by T. K. Homomixer (Tokushukika Kogyo Comapny), the oily liquid was added thereto and continued to stir for 30 minutes to give a dispersion. The dispersion was allowed to proceed with stirring at 500 rpm in a constant temperature bath of 60° C. for 14 hours to give a suspension of microencapsulated composition. To the suspension was added aqueous solution containing 0.2% of Kelzan S (xanthan gum, Sanisho Company) to make the concentration of fenitroyhion 10%. The average particle diameter was measured and the result of 18 μm was obtained. The wall thickness was 0.12 μm.

### Reference Example 4

Ninety-six grams (96 g) of PYROCIDE-50 (50% natural pyrethrins, McLaughlin Gormley King Company) and 6 g of Sumidur L (polyisocyanate, Sumika-Bayer Urethane Company) were mixed to give an oily liquid. On the other hand, 6 g of Gohsenol (polyvinyl alcohol, Nippon Synthetic Chemical Industry) and 2.9 g of ethylene glycol were dissolved in 120 g of ion-exchanged water to give an aqueous solution. While the aqueous solution was stirred at 6500 rpm by T. K. Homomixer (Tokushukika Kogyo Comapny), the oily liquid was added thereto and continued to stir for 60 minutes to give a dispersion. The dispersion was allowed to proceed with stirring at 500 rpm in a constant temperature bath of 60° C. for 14 hours to give a suspension of microencapsulated composition. To the suspension was added aqueous solution containing 0.2% of Kelzan S (xanthan gum, Sansho Company) to make the concentration of natural pyrethrins 10%. The average particle diameter was measured and the result of 4 μm was obtained. The wall thickness was 0.04 μm and pH was 5.2.

### Test Example 1

Twenty grams (20 g) of sand were put on a plastic Petri dish (9 cm in diameter). Each formulation obtained in Examples 1-4 and Reference examples 1 and 4 was diluted with ion-exchange water to a designated concentration, and 5 ml of the dilution was applied on the sand. Ten worker termites (Coptotermes formosanus) were released there just after the application or after keeping at 60° C. for a designated time. Mortality was observed 48 hours after releasing. The test was repeated three times and calculated the average. The result is given in Table 1.

TABLE 1

| | | Mortality (%) | | | | |
|---|---|---|---|---|---|---|
| | | Immediately | | | | |
| | Dilution | after | After 2 | After 3 | After 4 | After 5 |
| Samples | rate | application | months | months | months | months |
| Ex. 1 | ×50 | 100 | 100 | 100 | 90 | 53 |
| | ×100 | 100 | 97 | 77 | 63 | 43 |
| Ex. 2 | ×50 | 100 | 100 | 57 | 50 | 31 |
| | ×100 | 100 | 100 | 57 | 27 | 20 |
| Ex. 3 | ×50 | 100 | 100 | 100 | 100 | 100 |
| | ×100 | 100 | 100 | 100 | 55 | 47 |
| Ex. 4 | ×25 | 100 | 100 | 100 | 91 | 85 |
| | ×50 | 93 | 67 | 90 | 90 | 87 |
| Ref. | ×50 | 100 | 90 | 37 | 20 | 3 |
| Ex. 1 | | | | | | |
| | ×100 | 100 | 33 | 0 | — | — |
| Ref. | ×50 | 63 | — | — | — | — |
| Ex. 4 | | | | | | |
| | ×100 | 50 | — | — | — | — |
| Control | — | 0 | 0 | 0 | 0 | 0 |

### Test Example 2

Each formulation obtained in Examples 1-4 and Reference examples 1-3 was diluted with ion-exchange water to a designated concentration, and 0.3 ml of the dilution was applied on a bottom of a glass Petri dish (9 cm in diameter, 6 cm in height). Five female and five male cockroaches (Blattella germanica) were released there just after the application or after keeping at 45° C. for a designated time. After one hour, the cockroaches were moved to a clean container and the mortality was observed 24 hours after. The test was repeated three times and calculated the average. The result is given in Table 2.

TABLE 2

| | | Mortality (%) | | | |
|---|---|---|---|---|---|
| | Dilution | After | After 2 | After 4 | After 8 |
| Samples | rate | immediately | weeks | weeks | weeks |
| Ex. 1 | ×20 | 100 | 100 | 100 | 100 |
| | ×40 | 100 | 100 | 100 | 100 |
| Ex. 2 | ×20 | 100 | 100 | 100 | 100 |
| | ×40 | 100 | 100 | 100 | 100 |
| Ex. 3 | ×20 | 100 | 100 | 100 | 100 |
| | ×40 | 100 | 100 | 100 | 100 |
| Ex. 4 | ×40 | 100 | 100 | 100 | 100 |
| | ×80 | 100 | 100 | 100 | 100 |
| Ref. | ×20 | 100 | 0 | — | — |
| Ex. 1 | | | | | |
| | ×40 | 100 | 0 | — | — |
| Ref. | ×40 | 100 | 0 | — | — |
| Ex. 2 | | | | | |
| | ×80 | 100 | 0 | — | — |
| Ref. | ×40 | 100 | 100 | 100 | 0 |
| Ex. 3 | | | | | |
| | ×80 | 100 | 100 | 80 | 0 |
| Control | — | 0 | 0 | 0 | 0 |

### Test Example 3

Ten carp fry (about 5 cm of full length) were put into a 15 liter-glass tank having 10 liters of water. After acclimating the carp fry for one week, each formulation obtained in Examples 1, 4 and Reference example 1 was added to the tank to make the concentration designated. After 48 hours, mortality of the carp fry was observed and TLm48 was calculated. The result is given in Table 3.

| Samples | TLm48 (ppm) |
|---|---|
| Ex. 1 | >10 |
| Ex. 4 | >10 |
| Ref. Ex. 1 | 0.08 |

What is claimed is:

1. A microencapsulated insecticidal composition comprising a pyrethrin encapsulated in a wall formed of a synthetic polymer and having an average particle diameter of 5 to 100 μm and wall thickness of 0.03 to 1 μm.

2. A microencapsulated insecticidal composition according to claim 1, wherein the synthetic polymer is polyurethane or polyurea.

3. An insecticidal aqueous suspension which comprises a pyrethrin encapsulated in a wall formed of a synthetic polymer and having an average particle diameter of 5 to 100 μm and wall thickness of 0.03 to 1 μm.

4. An insecticidal aqueous suspension according to claim 3, wherein the synthetic polymer is polyurethane or polyurea.

5. An insecticidal aqueous suspension according to claim 3 or 4, wherein the pH of the aqueous suspension is 2 or more and less than 7.

6. An insecticidal aqueous suspension according to claim 3 or 4, wherein the pH of the aqueous suspension is in the range of 2 to 6.5.

7. A method for controlling insects which comprises applying an effective amount of microencapsulated insecticidal composition comprising a pyrethrin encapsulated in a wall formed of a synthetic polymer and having an average particle diameter of 5 to 100 μm and wall thickness of 0.03 to 1 μm.

8. A method for controlling insects according to claim 7, wherein the synthetic polymer is polyurethane or polyurea.

9. A method for controlling insects according to claim 7 or 8, wherein the insect is termite.

10. A method for controlling insects according to claim 7 or 8, wherein the insect is cockroach.
